(19) United States
(12) Patent Application Publication
(10) Pub. No.: US 2026/0296378 A1
(43) Pub. Date: Oct. 1, 2026

(54) SYSTEMS AND METHODS FOR VEHICLE LICENSE PLATE CLEANING

(71) Applicant: Ford Global Technologies, LLC, Dearborn, MI (US)

(72) Inventors: Mahmoud Yousef Ghannam, Canton, MI (US); Aed M. Dudar, Canton, MI (US)

(73) Assignee: Ford Global Technologies, LLC, Dearborn, MI (US)

(21) Appl. No.: 19/097,373

(22) Filed: Apr. 1, 2025

(51) Int. Cl. B60S 3/04; B08B 3/02; B08B 13/00; B60R 13/10; B64D 1/18; G06T 7/00

(52) U.S. Cl. CPC B60S 3/04; B08B 3/02; B08B 13/00; B64D 1/18; G06T 7/0002; B60R 13/10

(57) ABSTRACT

A vehicle including a license plate, a transceiver, and a processor is disclosed. The transceiver may receive an image of the license plate from an external device. The processor may obtain the image of the license plate from the transceiver and determine if the license plate is dirty based on the image. Responsive to a determination that the license plate is dirty, the processor may perform a predetermined action to clean the license plate.

### FIELD

The present disclosure relates to vehicles and more specifically to systems and methods for license plate cleaning.

### BACKGROUND

Vehicle license plates are susceptible to accumulating dirt and debris from the external environment, especially for users who frequently drive on unpaved or dirty roads. Dust, mud, and other elements may obscure the visibility of the license plate, making it difficult for users to read. The issue of dirty license plates becomes even more relevant for self-driving or autonomous vehicles, where there is no human presence to notice or address the dirty license plate. In human-driven vehicles, users rely on their vision to spot a dirty or obscured license plate and take actions to clean it. However, the users may sometimes not notice that the vehicle license plate may be dirty. It is desirable to keep the vehicle license plates clean.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of a system to facilitate cleaning of a vehicle license plate in accordance with the present disclosure.

FIG. 3 depicts a first example scenario of using vehicle-to-vehicle (V2V) communication to facilitate cleaning of a vehicle license plate in accordance with the present disclosure.

FIG. 4 depicts an example cleaning mechanism to facilitate cleaning of a vehicle license plate in accordance with the present disclosure.

FIG. 5 depicts a second example scenario of using vehicle-to-drone (V2D) communication to facilitate cleaning of a vehicle license plate in accordance with the present disclosure.

FIG. 6 depicts a third example scenario of using vehicle-to-infrastructure (V2X) communication to facilitate cleaning of a vehicle license plate in accordance with the present disclosure.

FIG. 7 depicts a flow diagram of an example method to facilitate cleaning of a vehicle license plate in accordance with the present disclosure.

### DETAILED DESCRIPTION

### Overview

The present disclosure describes a system and method that facilitates cleaning of a license plate associated with a vehicle (e.g., a “first vehicle”). The system may first determine that the license plate may be dirty. Responsive to a determination that the license plate may be dirty, the system may perform a predetermined action to clean the license plate. In an exemplary aspect, the license plate may become dirty when the vehicle has traveled (or is traveling) in an off-road area (or a dirty area/road), when the vehicle has traveled (or is traveling) in a storm such as dust storm, snowstorm, etc., when the vehicle may be parked in a storm area, and/or the like.

To determine that the license plate may be dirty, the system may obtain a license plate image (or a “first image”) from an external device. The external device may be, for example, a second vehicle located in proximity to the first vehicle, a drone, a smart infrastructure unit (e.g., a camera), and/or the like. In an exemplary aspect, the system may obtain the license plate image from the second vehicle via vehicle-to-vehicle (V2V) communication, from the drone via vehicle-to-drone (V2D) communication, and from the smart infrastructure unit via vehicle-to-everything (V2X) communication.

In some aspects, before the system obtains the license plate image from the external device, the system may first determine a probability that the license plate may be dirty based on route information associated with a vehicle route on which the first vehicle may be traveling (or the route the first vehicle may have traveled recently). The system may transmit a request to the external device (e.g., the second vehicle) to capture the license plate image and provide the license plate image to the system, when the probability that the license plate may be dirty is greater than a predefined threshold. The probability may be greater than the predefined threshold when the first vehicle has traveled (or is traveling) through the dirty area, when the first vehicle has traveled (or is traveling) during the storm, when the first vehicle may be parked in the storm area, and/or the like. Responsive to transmitting the request, the system may obtain the license plate image from the external device.

Responsive to obtaining the license plate image from the external device, the system may determine that the license plate may be dirty based on the obtained license plate image. Further, responsive to determining that the license plate may be dirty, the system may perform the predetermined action to clean the license plate. The predetermined action may include outputting a notification for a user (e.g., a vehicle operator) on a user interface associated with a vehicle Human-Machine Interface (HMI) or a user device. The notification may indicate to the user that the license plate is dirty and requires cleaning. In another aspect, the predetermined action may include activating a sprayer installed in the first vehicle, which may spray cleaning liquid (e.g., water) on the license plate to clean the license plate (e.g., to remove dust, snow, etc., from the license plate). In yet another aspect, the predetermined action may include transmitting a request to the drone to spray the cleaning liquid on the license plate (e.g., when the first vehicle may be parked in a parking area). In another aspect, the system may schedule a vehicle wash to facilitate license plate cleaning. In yet another aspect, the system may perform opportunistic cleaning by using rainwater based on rain forecast.

Responsive to performing the predetermined action to clean the license plate as described above, the system may verify that the license plate is clean or still dirty. In some aspects, the system may perform the verification after a predefined time duration (e.g., 10 minutes, 30 minutes, 1 hour, 3 hours, etc.) of performing the predetermined action. To perform the verification, the system may request the external device to capture another image (or a second image) of the license plate and provide the second image to the system. The system may obtain the second image and determine that the license plate is clean (or still dirty) based on the second image. Responsive to a determination that the license plate is clean, the system may output another notification (or a second notification) for the user indicating that the license plate is clean. Alternatively, the system may repeat and continue to perform the predetermined action described above till the license plate is clean.

The present disclosure discloses a vehicle that uses vehicle's existing components to determine whether the license plate is dirty or clean and facilitates license plate cleaning. The vehicle utilizes vehicle's capability to communicate with the external device(s) to detect dirty license plate and performs cleaning operation accordingly. In some scenarios, the vehicle may not require human presence to keep the license plate clean.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

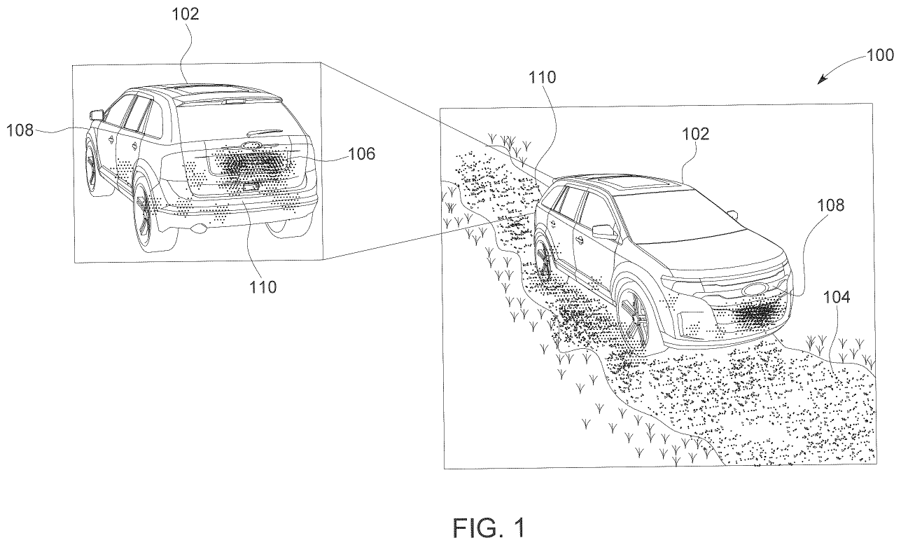

FIG. 1 depicts an example environment 100 in which techniques and structures for providing the systems and methods disclosed herein may be implemented. The environment 100 may include a vehicle 102 (hereinafter referred as a first vehicle 102) that may be traveling on an off-road area 104. Alternatively, the first vehicle 102 may be traveling on a road that may be dirty (e.g., covered with dirt, snow, etc.), or the first vehicle 102 may be traveling on the road (or the off-road area 104) during a storm such as dust storm, snowstorm, etc.

The first vehicle 102 may take the form of any passenger or commercial vehicle such as a car, a work vehicle, a crossover vehicle, a truck, a van, a minivan, a taxi, a bus, etc. The first vehicle 102 may be a manually driven vehicle or may be configured to operate in a partially/fully autonomous mode. Further, the first vehicle 102 may include any powertrain, such as a gasoline engine, one or more electrically-actuated motor(s), or a hybrid system.

The first vehicle 102 may include a license plate 106 that identifies the first vehicle 102. The license plate 106 may be a rectangular metal plate having a unique alphanumeric code that identifies the first vehicle 102. In some aspects, the first vehicle 102 may have two license plates, one plate attached to a vehicle front portion 108 and another plate attached to a vehicle rear portion 110, both of which may be mounted at a vehicle interior or exterior portion. Alternatively, the first vehicle 102 may have only one license plate that may be attached to the vehicle rear portion 110. In some aspects, the license plate 106 may be made of sheet metal or the like. In further aspects, the license plate 106 may be in the form of a digitized display.

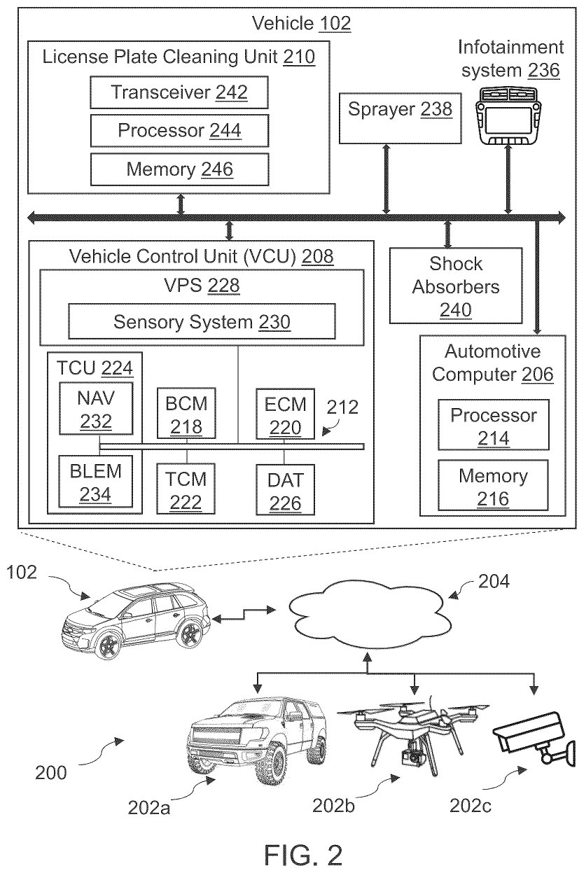

The first vehicle 102 may further include a license plate cleaning unit (shown as license plate cleaning unit 210 in FIG. 2) that may determine a license plate state and perform one or more predefined actions based on the determined state. For example, the license plate cleaning unit (or “unit”) may determine the license plate state as being dirty and perform a predetermined action to clean the license plate 106 responsive to such determination. In an exemplary aspect, the license plate 106 may become dirty when the first vehicle 102 travels in the off-road area 104 (or dirty area/road), when the first vehicle 102 travels in a storm (e.g., dust storm, snowstorm, etc.), when the first vehicle 102 may be parked in a storm area, and/or the like. In some aspects, the unit may determine that both the license plates located at the vehicle front portion 108 and the vehicle rear portion 110 may be dirty (e.g., when the first vehicle 102 includes two license plates). Alternatively, the unit may determine that one license plate may be dirty (e.g., when the first vehicle 102 may include a single license plate at the vehicle rear portion 110).

In some aspects, the first vehicle 102 may be communicatively coupled to an external device. The external device may be, for example, a second vehicle (shown as a second vehicle 202a in FIG. 2) located in proximity to the first vehicle 102, a drone (shown as a drone 202b in FIG. 2), a smart infrastructure unit such as an infrastructure camera (shown as a camera 202c in FIG. 2), and/or the like. The first vehicle 102 may be communicatively coupled to the external device via a network (shown as network 204 in FIG. 2). In an exemplary aspect, the first vehicle 102 may communicate with the second vehicle via vehicle-to-vehicle (V2V) communication, the first vehicle 102 may communicate with the drone via vehicle-to-drone (V2D) communication, and the first vehicle 102 may communicate with the smart infrastructure unit via vehicle-to-everything (V2X) communication.

In some aspects, to determine the license plate state, the unit may obtain a license plate image (or first image) associated with the license plate 106 from the external device, via the network. In some aspects, the unit may initially request the external device to capture the license plate image and provide the captured license plate image to the unit. Responsive to transmitting the request, the unit may obtain the license plate image from the external device. In an exemplary aspect, the unit may request the external device to capture the license plate image located at the vehicle front portion 108 and/or the vehicle rear portion 110.

In some aspects, before transmitting the request to the external device, the unit may first determine a probability that the license plate 106 may be dirty based on route information associated with a vehicle route on which the first vehicle 102 may be traveling (or the route that the first vehicle 102 may have traveled recently on). The route information may include weather conditions in the vehicle route, road conditions in the vehicle route, information associated with off-road area presence in the vehicle route, and/or the like. For instance, based on the route information, the unit may estimate that the first vehicle 102 may move through the off-road area between 9 AM-10 AM and may estimate that it may rain in the off-road area between 9 AM-10 AM. Based on such estimation, the unit may determine that the probability that the license plate 106 may be dirty is high or higher than a predefined threshold (as the off-road area surface may be muddy). In an exemplary aspect, the unit may correlate the road condition information with the weather condition information, and calculate the probability based on the correlation. For example, whenever the road condition information indicates a presence of an off-road area in the vehicle route and the weather condition information indicates a presence of rain, snow, etc. (when the vehicle 102 may travel through the off-road area), the unit may correlate these two conditions to calculate the probability of the license plate 106 getting dirty as being high. On the other hand, if the road condition information indicates that the road may be a high grade concrete road, the unit may calculate the probability of the license plate 106 getting dirty as being low.

Responsive to determining the probability, the unit may transmit the request to the external device to provide the license plate image based on the probability. In some aspects, the unit may transmit the request to the external device when the probability that the license plate 106 may be dirty is greater than a predefined threshold. The probability may be greater than the predefined threshold when the first vehicle 102 has traveled (or is traveling) through the dirty area, when the first vehicle 102 has traveled (or is traveling) during the storm, when the first vehicle 102 is parked in the storm area, and/or the like.

Responsive to obtaining the license plate image from the external device, the unit may determine that the license plate 106 may be dirty based on the obtained license plate image. The unit may perform image processing on the obtained license plate image to determine that the license plate 106 may be dirty or obscured. In some aspects, the unit may compare the obtained license plate image with a pre-stored image (stored in a vehicle memory) and may determine that the license plate 106 may be dirty based on the comparison (e.g., when the license plate 106 is not readable).

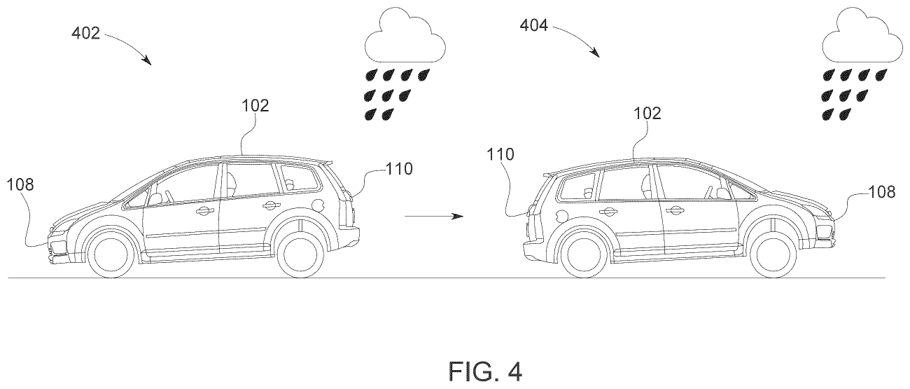

Responsive to determining that the license plate 106 may be dirty, the unit may perform a predetermined action to clean the license plate 106. The predetermined action may include, for example, outputting a notification to a user (e.g., a vehicle operator) via a user interface (associated with a vehicle Human-Machine Interface (HMI) or a user device). The notification may indicate that the license plate 106 is dirty and requires cleaning. In another aspect, the predetermined action may include activating a sprayer (shown as a sprayer 238 in FIG. 2), which may spray a cleaning liquid (e.g., water) on the license plate 106 to clean the license plate 106 (e.g., to remove dust, snow, etc., from the license plate 106). The sprayer may an integral part of the first vehicle 102 or may be removably attached to the first vehicle 102. In yet another aspect, the predetermined action may include transmitting a request to the drone to spray the cleaning liquid on the license plate 106 (e.g., when the first vehicle 102 may be parked in a parking area). In another aspect, the unit may automatically schedule a vehicle wash to facilitate license plate cleaning, responsive to determining that the license plate 106 is dirty. In yet another aspect, the unit may perform opportunistic cleaning using rainwater based on rain forecast. This aspect is described later below in conjunction with FIG. 4.

Responsive to performing the predetermined action as described above, the unit may verify that the license plate 106 is clean or still dirty. In some aspects, the unit may perform the verification step after a predefined time duration (e.g., 5 minutes, 10 minutes, 30 minutes, 1 hour, 3 hours, etc.) of performing the predetermined action described above. To perform the verification, the first vehicle 102 may request the external device to capture another image (or a “second image”) of the license plate 106 and provide the second image to the unit. The unit may obtain the second image and may determine that the license plate 106 is clean (or still dirty) based on the second image. Responsive to a determination that the license plate 106 is clean, the unit may output another notification (or a second notification) to the user indicating that the license plate 106 is now clean. Alternatively, the unit may again activate the sprayer to clean the license plate 106. The unit may repeat to perform the predetermined action described above until the license plate 106 is clean.

The present disclosure describes cleaning of the license plate 106 that may be mounted on the vehicle's exterior portion; however, such description should not be construed as limiting the applicability of the disclosure to only externally mounted license plates. In some aspects, the license plate 106 may be mounted inside the first vehicle 102. In some aspects, the license plate 106 may be a paper plate (e.g., when the license plate 106 may be temporary). In such scenarios, the unit may obtain the license plate image from the external device and determine that the license plate 106 may be covered with dirt/snow based on the obtained license plate image (as described above). The license plate 106 (mounted inside the vehicle 102) may be covered with dirt/snow when a rear windshield may be covered with dirt, snow, etc. Responsive to such determination, the unit may perform onboard cleaning to reveal the license plate 106. For instance, the unit may activate the rear wipers, fluid spray, defroster, and/or the like to reveal the license plate 106.

Further vehicle details are described below in conjunction with FIG. 2.

The first vehicle 102 implements and/or performs operations, as described here in the present disclosure, in accordance with the owner manual and safety guidelines. In addition, any action taken by the user based on the notifications provided by the first vehicle 102 should comply with all the rules specific to the location and operation of the first vehicle 102 (e.g., Federal, state, country, city, etc.). The notifications, as provided by the first vehicle 102, should be treated as suggestions and only followed according to any rules specific to the location and operation of the first vehicle 102.

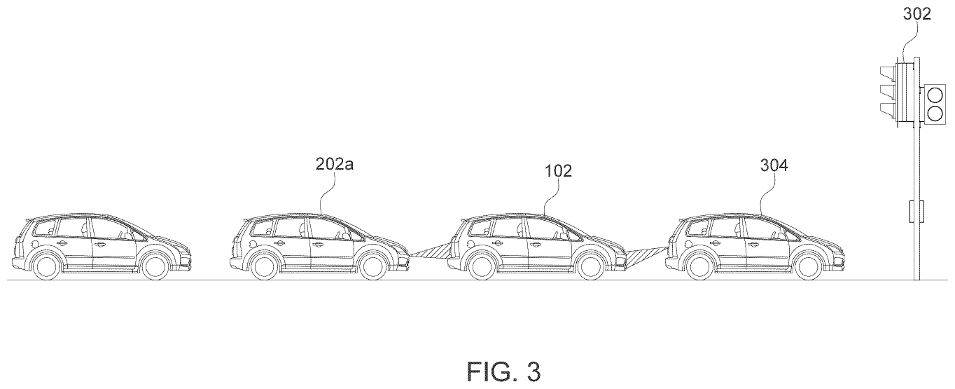

FIG. 2 depicts a block diagram of a system 200 to facilitate cleaning of the license plate 106 in accordance with the present disclosure. While describing FIG. 2, references will be made to FIGS. 3, 4, 5 and 6.

The system 200 may include the first vehicle 102 and the external device (including a second vehicle 202a, a drone 202b and/or a smart infrastructure unit such as a camera 202c) that may be communicatively coupled with each other via one or more networks 204.

The network(s) 204 illustrates an example communication infrastructure in which the connected devices discussed in various embodiments of this disclosure may communicate. The network(s) 204 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The first vehicle 102 may include a plurality of units including, but not limited to, an automotive computer 206, a Vehicle Control Unit (VCU) 208 and a license plate cleaning unit 210 (or unit 210). The VCU 208 may include a plurality of Electronic Control Units (ECUs) 212 in communication with the automotive computer 206.

In some aspects, the automotive computer 206 and/or the unit 210 may be installed anywhere in the first vehicle 102, in accordance with the disclosure. Further, the automotive computer 206 may operate as a functional part of the unit 210. The automotive computer 206 may be or include an electronic vehicle controller, having one or more processor(s) 214 and a memory 216. Moreover, the unit 210 may be separate from the automotive computer 206 (as shown in FIG. 2) or may be integrated as part of the automotive computer 206.

The processor(s) 214 may be in communication with one or more memory devices in communication with the respective computing systems (e.g., the memory 216 and/or one or more external databases not shown in FIG. 2). The processor(s) 214 may utilize the memory 216 to store programs in code and/or to store data for performing aspects in accordance with the disclosure. The memory 216 may be a non-transitory computer-readable medium or memory storing a license plate cleaning program code. The memory 216 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 208 may share a power bus with the automotive computer 206 and may be configured and/or programmed to coordinate the data between first vehicle 102 systems, connected servers (not shown), and other vehicles (including the second vehicle 202a) operating as part of a vehicle fleet. The VCU 208 may include or communicate with any combination of the ECUs 212, such as a Body Control Module (BCM) 218, an Engine Control Module (ECM) 220, a Transmission Control Module (TCM) 222, a Telematics Control Unit (TCU) 224, a Driver Assistances Technologies (DAT) controller 226, etc.

The VCU 208 may further include and/or communicate with a Vehicle Perception System (VPS) 228, having connectivity with and/or control of one or more vehicle sensory system(s) 230 (or a “sensor unit”). The vehicle sensory system 230 may include one or more vehicle sensors including, but not limited to, a radio detection and ranging (radar) sensor configured for detection and localization of objects inside and outside the first vehicle 102 using radio waves, sitting area buckle sensors, sitting area sensors, a light detecting and ranging (lidar) sensor, door sensors, proximity sensors, temperature sensors, wheel sensors, ambient weather sensors, ambient light sensors, vehicle interior and exterior cameras, one or more rain sensors, a humidity sensor, a tire pressure sensor, ultrasonic sensors, etc.

In some aspects, the VCU 208 may control vehicle operational aspects and implement one or more instruction sets received from a user device associated with a user (or vehicle operator), from one or more instruction sets stored in the memory 216, including instructions operational as part of the unit 210.

The TCU 224 may provide vehicle connectivity to wireless computing systems onboard and off board the first vehicle 102 and may include a Navigation (NAV) receiver 232 for receiving and processing a GPS signal, a BLE Module (BLEM) 234, a Wi-Fi transceiver, a UWB transceiver, and/or other wireless transceivers (not shown in FIG. 2) that may be configurable for wireless communication (including cellular communication) between the first vehicle 102 and other systems (e.g., a user device, a key fob, an NFC device, etc.), computers, and modules. The NAV receiver 232 may be configured to determine a real-time vehicle geolocation. The TCU 224 may be in communication with the ECUs 212 by way of a bus.

The ECUs 212 may control aspects of vehicle operation and communication using inputs from human drivers, inputs from an autonomous vehicle controller, the unit 210, and/or via wireless signal inputs received via the wireless connection(s) from other connected devices, such as the user device associated with the vehicle user, the server(s), among others.

The BCM 218 generally includes integration of sensors, vehicle performance indicators, and variable reactors associated with vehicle systems and may include processor-based power distribution circuitry that can control functions associated with the vehicle body such as lights, windows, security, camera(s), fan, headlights, audio system(s), speakers, wipers, door locks and access control, mirrors, various comfort controls, a sprayer 238 (described below), one or more shock absorbers 240, and/or the like. The BCM 218 may also operate as a gateway for bus and network interfaces to interact with remote ECUs (not shown in FIG. 2).

The DAT controller 226 may provide Level-1 through Level-3 automated driving and driver assistance functionality that may include, for example, active parking assistance, vehicle backup assistance, and adaptive cruise control, among other features. The DAT controller 226 may also provide aspects of user and environmental inputs usable for user authentication.

In some aspects, the automotive computer 206 may connect with an infotainment system 236 (or a vehicle Human-Machine Interface (HMI) 236). The infotainment system 236 may include a touchscreen interface portion and may include voice recognition features, biometric identification capabilities that can identify users based on facial recognition, voice recognition, fingerprint identification, or other biological identification means. In other aspects, the infotainment system 236 may further receive user instructions/inputs via the touchscreen interface portion and/or display notifications/recommendations, navigation maps, etc. on the touchscreen interface portion.

The first vehicle 102 may further include the sprayer 238 that may spray a cleaning liquid (e.g., water) on the license plate 106 to clean the license plate 106. The sprayer 238 may be an integral part of the first vehicle 102 or may be removably attached to the first vehicle 102. The sprayer 238 may be located in proximity to the license plate 106. For example, the sprayer 238 may be located just above the license plate 106. The first vehicle 102 may further include one or more shock absorbers 240 that may be a part of a vehicle suspension system, which may be designed to absorb and damp shock impulses. The shock absorbers 240 may dampen motion of springs, which may be part of the vehicle suspension system.

The computing system architecture of the automotive computer 206, the VCU 208, and/or the unit 210 may omit certain computing modules. It should be readily understood that the computing environment depicted in FIG. 2 is an example of a possible implementation according to the present disclosure, and thus, it should not be considered limiting or exclusive.

In accordance with some aspects, the unit 210 may be integrated with and/or executed as part of the ECUs 212. The unit 210, regardless of whether it is integrated with the automotive computer 206 or the ECUs 212, or whether it operates as an independent computing system in the first vehicle 102, may include a transceiver 242, a processor 244, and a computer-readable memory 246.

The transceiver 242 may receive information/inputs from one or more external devices or systems, e.g., the user device associated with the vehicle user, the external device described above, and/or the like via the network 204. For example, the transceiver 242 may receive the license plate image from the external device via the network 204. Further, the transceiver 242 may transmit notifications/data/signals (including requests/command signals) to the external device. In addition, the transceiver 242 may receive information/inputs from the first vehicle 102 components such as the infotainment system 236, the VCU 208, and/or the like. Further, the transceiver 242 may transmit notifications/command signals to the first vehicle 102 components such as the VCU 208, the infotainment system 236, the BCM 218, etc.

The processor 244 and the memory 246 may be the same as or similar to the processor 214 and the memory 216, respectively. In some aspects, the processor 244 may utilize the memory 246 to store programs in code and/or to store data for performing aspects in accordance with the disclosure. The memory 246 may be a non-transitory computer-readable medium or memory storing the license plate cleaning program code. In some aspects, the memory 246 may store the license plate images (obtained from the external device) and a pre-stored image of the first vehicle 102 with the license plate 106 (along with other vehicle attributes/details).

In operation, the processor 244 may obtain a license plate image (or a “first image”) associated with the license plate 106 from the external device, via the transceiver 242. Responsive to obtaining the license plate image, the processor 244 may determine that the license plate 106 may be dirty based on the license plate image (e.g., by executing an image processing algorithm on the obtained license plate image). The processor 244 may perform a first predetermined action to clean the license plate 106 responsive to a determination that the license plate 106 is dirty.

In a first exemplary aspect, the external device may be the second vehicle 202a that may be located in proximity to the first vehicle 102. For example, the second vehicle 202a may be located in proximity to the vehicle rear portion 110. The first vehicle 102 may communicate with the second vehicle 202a via V2V communication. When the first vehicle 102 may be at an idle stop in proximity to a traffic light 302 (as shown in FIG. 3) or traveling at a steady state speed on a highway during daylight hours, the processor 244 associated with the first vehicle 102 may transmit a request to the second vehicle 202a to capture the license plate image associated with the license plate 106. The second vehicle 202a may receive the request and capture the license plate image via a second vehicle camera (located at a second vehicle front portion) responsive to receiving the request. Responsive to capturing the license plate image, the second vehicle 202a may transmit the license plate image to the processor 244. In some aspects, the second vehicle 202a may perform cleaning operation of camera lens (and/or windshield) associated with the second vehicle 202a or perform camera lens adjustment to optimally capture the license plate image.

In some aspects, before transmitting the request for image capture to the second vehicle 202a as described above, the processor 244 may determine a probability of the license plate 106 being dirty, and transmit the request to the second vehicle 202 (e.g., during day hours) based on the probability (e.g., when the probability may be high). In an exemplary aspect, to determine the probability, the processor 244 may obtain the route information associated with the vehicle route on which the first vehicle 102 may be traveling (or route that the first vehicle 102 may have recently traveled) from an external server. The route information may include weather conditions in the vehicle route, road conditions in the vehicle route, information associated presence or absence of the off-road area 104 in the vehicle route, and/or the like. Responsive to obtaining the route information, the processor 244 may determine the probability based on the route information. For instance, based on the route information, the processor 244 may estimate that the first vehicle 102 may move through the off-road area between 9 AM-10 AM, and estimate that it may rain in the off-road area between 9 AM-10 AM. Based on such estimation, the processor 244 may determine that the probability that the license plate 106 may be dirty is high or higher than a predefined threshold (as the off-road area surface may be muddy). The processor 244 may then compare the probability with a predefined threshold. The processor 244 may transmit the request to the second vehicle 202 when the probability of the license plate 106 being dirty is greater than the predefined threshold. In an exemplary aspect, the probability may be greater than the predefined threshold when the processor 244 determines that the first vehicle 102 has traveled (or is traveling) through a dirty area, a storm, and/or the like.

The processor 244 may determine that the probability of the license plate 106 being dirty is greater than the predefined threshold based on other conditions as well and is not limited to the conditions described above. For example, the processor 244 may determine that the probability is greater than the predefined threshold when the processor 244 determines that the first vehicle 102 is parked in a storm area (e.g., based on the inputs obtained from the vehicle sensory system 230). In another example, the processor 244 may determine that the probability is greater than the predefined threshold when the processor 244 determines that a third vehicle 304 moving ahead of the first vehicle 102 has a dirty license plate (and the first vehicle 102 and the third vehicle 304 are traveling/have traveled on the same road/off-road area).

The processor 244 may further determine which license plate may be dirty (in addition to determining the probability of the license plate 106 being dirty) based on the factors described above (including the route information). For example, the processor 244 may determine whether both the license plates located on the vehicle front portion 108 and the vehicle rear portion 110 may be dirty, or only one license plate located on the vehicle rear portion 110 may be dirty (e.g., when the first vehicle 102 has two license plates, one on the vehicle front portion 108 and another on the vehicle rear portion 110). Based on such determination, the processor 244 may select the vehicle located ahead or behind the first vehicle 102 to capture the license plate image and transmit the request to the selected vehicle. For example, the processor 244 may select the second vehicle 202a (and may not select the third vehicle 304) located behind the first vehicle 102 when the processor 244 determines that the license plate located on the vehicle rear portion 110 may be dirty and transmit the request to the selected second vehicle 202a. In a scenario where the first vehicle 102 may have only one license plate at the vehicle rear portion 110 (and may not have any license plate at the vehicle front portion 108), the processor 244 may request only the vehicle behind the first vehicle 102 to capture the license plate image (as the license plate image from the vehicle moving ahead is not needed).

When the processor 244 transmits the request to the second vehicle 202a, the second vehicle 202a may use its in-built camera (e.g., an exterior view camera located at a second vehicle front portion) to capture the license plate image associated with the license plate 106 and transmit the license plate image to the processor 244. The processor 244 may obtain the license plate image from the second vehicle 202a. After receiving the license plate image, the processor 244 may perform image processing on the obtained license plate image to determine that the license plate 106 may be dirty or obscured. In some aspects, the processor 244 may compare the obtained license plate image with the pre-stored image of the first vehicle 102 with the license plate 106 (stored in the memory 246) and determine that the license plate 106 may be dirty/obscured based on the comparison (e.g., when the license plate 106 is not readable). In some aspects, the processor 244 may use machine learning models to determine whether the license plate 106 is dirty based on the obtained license plate image.

Responsive to a determination that the license plate 106 may be dirty, the processor 244 may perform the first predetermined action to clean the license plate 106. In some aspects, processor 244 may transmit/output a first notification on a user interface associated with the infotainment system 236 and/or the user device as part of the first predetermined action. The first notification may indicate to the user that the license plate 106 (e.g., rear and/or front license plates) is dirty and requires cleaning. The user/vehicle operator may view/hear the notification and accordingly perform manual cleaning of the license plate 106.

In further aspects, as part of the first predetermined action, the processor 244 may activate (or turn-on) the sprayer 238 for a first predetermined time duration (e.g., 30 seconds) to spray cleaning fluid on the dirty license plate 106, to remove snow/dust from the license plate 106. The cleaning fluid may be water or any other fluid that may clean the license plate 106. In further aspects, as part of the first predetermined action, the processor 244 may schedule a vehicle wash to clean the license plate 106. For example, when the first vehicle 102 may be an autonomous vehicle, the processor 244 may automatically schedule the vehicle wash for the first vehicle 102.

In further aspects, as part of the first predetermined action, the processor 244 may perform opportunistic license plate cleaning by using rainwater based on rain forecast. To perform such a cleaning, the processor 244 may first obtain information associated with weather conditions in an area where the first vehicle 102 may be located, from an external server (not shown). The processor 244 may then predict a possibility of rainfall in the area based on the obtained weather condition information. Responsive to the rainfall prediction (i.e., when the processor 244 determines that the possibility may be high), the processor 244 may cause vehicle position adjustment such that the rain may fall on the license plate 106. For example, when the first vehicle 102 is parked in an open parking area (or partially open area) and the processor 244 predicts that it may rain soon (or it is raining), the processor 244 may cause the vehicle adjustment to facilitate license plate cleaning through the rainfall. The processor 244 may perform the vehicle adjustment to increase the likelihood of rain striking the license plate 106 (and thus cleaning the license plate 106).

In this case, the processor 244 may transmit a command signal to the BCM 218 to adjust the shock absorbers 240 and the vehicle orientation to facilitate license plate cleaning. For instance, the processor 244 may position the first vehicle 102 in a first orientation (e.g., the vehicle front portion 108 facing a predefined structure such as user home) and adjust the shock absorbers 240 to move the first vehicle 102 in a nose down orientation as shown in a view 402 of FIG. 4. In the nose down configuration, the front shock absorbers may be lowered and the rear shock absorbers may be raised to increase the likelihood of the rain striking the license plate 106 located at the vehicle rear portion 110 (as the surface area associated with the license plate 106 facing the rain has increased in this position).

In the scenario in which the dirty license plate is located at the vehicle front portion 108, the processor 244 may readjust the vehicle position to facilitate the license plate cleaning of other the license plate located at the vehicle front portion 108. For instance, in this case, the processor 244 may change the vehicle orientation from the first orientation to a second orientation (e.g., the vehicle rear portion 110 facing the predefined structure), after a predetermined time duration (e.g., after 10-15 minutes). In addition, the processor 244 may adjust the shock absorbers 240 to move the first vehicle 102 in a nose up orientation as shown in a view 404 of FIG. 4. In the nose up configuration, the front shock absorbers may be raised and the rear shock absorbers may lowered to increase the likelihood of rain striking the license plate 106 located at the vehicle front portion 108.

Responsive to performing the license plate cleaning operation by using any of the methods described above, the processor 244 may verify that the license plate 106 is clean or still dirty. The processor 244 may perform such verification after a predetermined duration (e.g., after 1-3 hours) of performing the first predetermined action described above. To perform the verification, the processor 244 may obtain a second image associated with the license plate 106 from the external device (in the same manner as the first image described above). Based on the second image, the processor 244 may verify that the license plate 106 is clean or still dirty (e.g., by using the image processing method described above). The processor 244 may then perform a second predetermined action based on the verification.

For instance, when the processor 244 verifies that the license plate 106 is clean, the processor 244 may output a second notification on the user interface indicating that the license plate 106 is clean. On the other hand, when the processor 244 determines that the license plate 106 is still dirty, the processor 244 may repeat the first predetermined action until the license plate 106 is clean. For instance, the processor 244 may output a third notification on the user interface indicating that the license plate 106 is still dirty. In another instance, the processor 244 may activate the sprayer 238 for a second predetermined time duration (e.g., another 30 seconds or 1 minute) when the license plate 106 is still dirty.

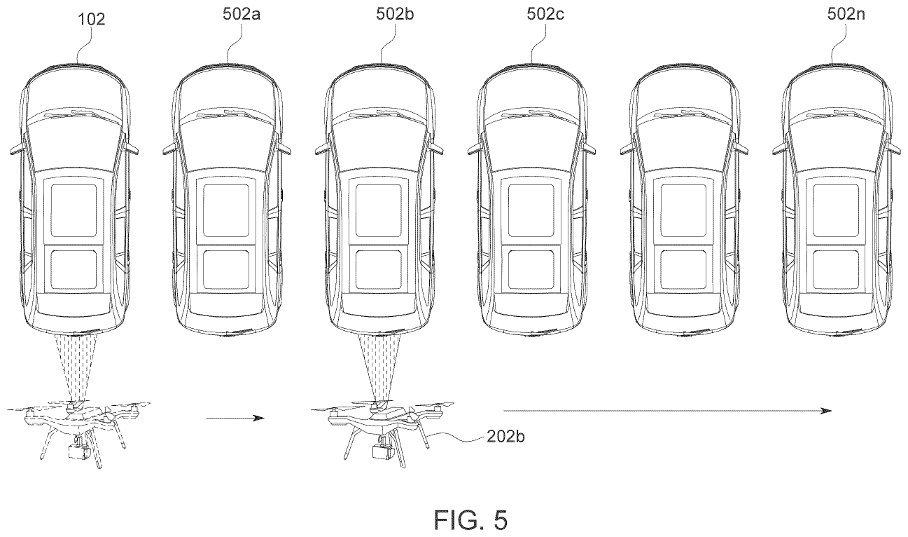

In further aspects, the external device described above may include the drone 202b. In this case, the processor 244 may utilize the drone 202b to facilitate the license plate cleaning via V2D communication, as shown in FIG. 5. For instance, when the first vehicle 102 is part of a fleet and parked in a parking area in which other vehicles (e.g., vehicles 502a, 502b . . . 502n, collectively referred to as other vehicles 502) are also parked, a fleet manager may utilize the drone 202b to facilitate license plate cleaning.

In some aspects, the drone 202b may fly behind and front of the parked vehicles (including the first vehicle 102 and the other vehicles 502) and capture the license plate images of respective vehicles. The drone 202b may transmit the license plate image associated with the first vehicle 102 to the processor 244, via the transceiver 242. In some aspects, the drone 202b may transmit the license plate image when the processor 244 transmits a request to the drone 202b to capture the license plate image. As described above, the processor 244 may transmit the request to the drone 202b to capture the license plate image when the processor 244 determines that the probability of the license plate 106 being dirty is greater than the predefined threshold. The processor 244 may obtain the license plate image from the drone 202b and determine that the license plate 106 may be dirty based on the obtained license plate image (in the same manner as described above).

Responsive to determining that the license plate 106 may be dirty, the processor 244 may perform the first predetermined action as described above. In some aspects, as part of the first predetermined action, the processor 244 may transmit a request to the drone 202b to spray cleaning fluid on the license plate 106 to clean the license plate 106. The drone 202b may receive the request and may spray the cleaning fluid on the first vehicle 102 (specifically on the license plate 106), via an onboard sprayer associated with the drone 202b. Similarly, the drone 202b may spray the cleaning fluid on the other vehicles 502 as well, if one or more of these vehicles may dirty license plates. The processor 244 may verify that the license plate 106 is clean, in the same manner as described above (e.g., by obtaining another image from the drone 202b), and perform the second predetermined action as described above.

In an alternative aspect, the drone 202b may fly over the first vehicle 102 and the other vehicles 502, capture the images of the respective license plates, and itself perform image processing on the captured images to determine that the license plate 106 may be dirty (and may not transmit the license plate image to the processor 244 for the analysis). In this case, responsive to a determination that the license plate 106 may be dirty, the drone 202b may itself spray the cleaning fluid on the license plate 106, via the onboard sprayer associated with the drone 202b (and may not need any request or command signal from the processor 244 to spray the cleaning fluid).

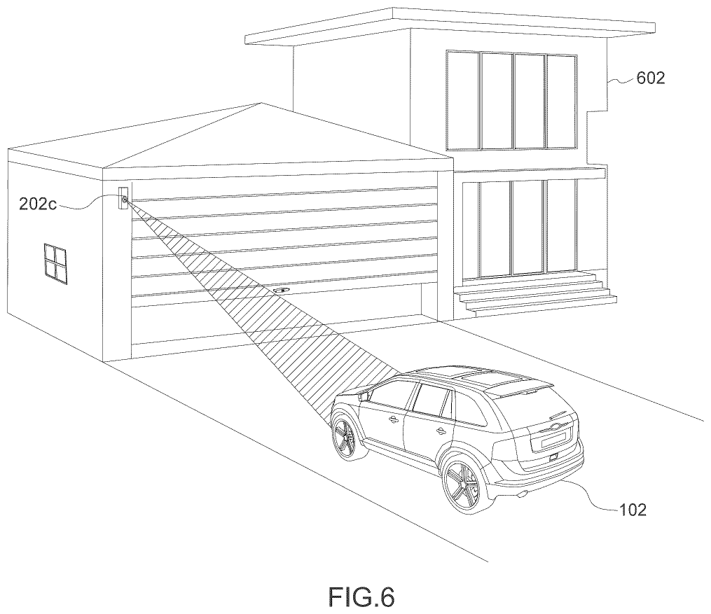

In yet another aspect, the external device may be the smart infrastructure unit such as the camera 202c. In some aspects, the camera 202c may be a smart security camera installed outside a user home 602, as shown in FIG. 6. In some aspects, the first vehicle 102 may be parked in a field-of-view (FOV) of the camera 202c, as shown in FIG. 6. In some aspects, the processor 244 may obtain the license plate image associated with the license plate 106 from the camera 202c, in the same manner as described above. In this case as well, the processor 244 may transmit a request to the camera 202c to provide the license plate image (e.g., when the processor 244 determines that the probability of the license plate 106 being dirty is greater than the predefined threshold). The processor 244 may obtain the license plate image responsive to transmitting the request. Based on the obtained image, the processor 244 may determine that the license plate 106 is dirty and may perform the first predetermined action to clean the license plate 106 (e.g., when the license plate 106 may be dirty), as described above.

In alternative aspects, the camera 202c (or any other smart infrastructure unit) may capture the license plate image and itself compare the license plate image with a pre-stored image (that may be stored in a camera memory) and may not transmit the license plate image back to the processor 244 for analysis. The pre-stored image may include vehicle type/color/license plate number. In this case, the camera 202c may perform image processing to compare the images and determine that the license plate 106 may be dirty based on the comparison. Responsive to a determination that the license plate 106 may be dirty, the camera 202c may transmit a notification to the user interface to indicate that the license plate 106 may be dirty, via V2X communication. In further aspects, the camera 202c may transmit a command signal to the processor 244 to perform the first predetermined action described above. In some aspects, when there may be multiple vehicles located in the camera's FOV, the camera 202c may determine which vehicle's license plate may be dirty (e.g., based on type/style/color/license plate) and may accordingly provide notification to the respective user/vehicle processor.

In further aspects, the camera 202c may be installed at toll road booths that may capture the license plate image. Such toll booth cameras may send notifications to the first vehicle 102 indicating that its license plate is dirty, via a smart electronic tag. The processor 244 may receive such notifications and may perform the first predetermined action to clean the license plate 106, as described above.

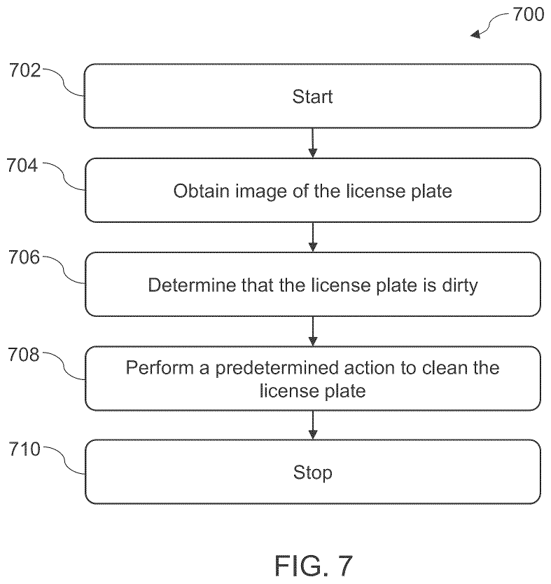

FIG. 7 depicts a flow diagram of an example method 700 to facilitate cleaning of a vehicle license plate in accordance with the present disclosure. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 700 starts at step 702. At step 704, the method 700 may include obtaining, by the processor 244, the license plate image from the external device (e.g., the second vehicle 202a, the drone 202b, or the camera 202c). At step 706, the method 700 may include determining, by the processor 244, that the license plate 106 may be dirty based on the obtained image. At step 708, the method 700 may include performing, by the processor 244, the first predetermined action to clean the license plate 106 responsive to a determination that the license plate 106 is dirty, as described above.

At step 710, the method 700 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A first vehicle comprising:
a license plate;
a transceiver configured to receive a first image of the license plate from an external device; and
a processor configured to:
obtain the first image from the transceiver;
determine if the license plate is dirty based on the first image; and
perform a first predetermined action to clean the license plate responsive to a determination that the license plate is dirty.

2. The first vehicle of claim 1, wherein the processor is further configured to transmit, via the transceiver, a request to the external device to capture the first image.

3. The first vehicle of claim 2, wherein the processor is further configured to:
determine a probability of the license plate being dirty based on route information of a vehicle trip;
compare the probability with a predefined threshold; and
transmit the request to the external device when the probability is greater than the predefined threshold.

4. The first vehicle of claim 3, wherein the probability is greater than the predefined threshold when the first vehicle has traveled through a certain area, when the first vehicle has traveled during a storm, or when the first vehicle is parked in a storm area.

5. The first vehicle of claim 2, wherein the external device is a second vehicle, and wherein the processor is configured to transmit the request via vehicle-to-vehicle (V2V) communication.

6. The first vehicle of claim 1, wherein to perform the first predetermined action, the processor is configured to output a first notification on a user interface indicating that the license plate is dirty.

7. The first vehicle of claim 1 further comprising a sprayer configured to spray cleaning liquid on the license plate to clean the license plate.

8. The first vehicle of claim 7, wherein to perform the first predetermined action, the processor is configured to activate the sprayer for a first predetermined time duration.

9. The first vehicle of claim 8, wherein the processor is further configured to:
obtain a second image from the external device after the first predetermined time duration;
verify that if license plate is clean based on the second image; and
perform a second predetermined action when the license plate is not clean.

10. The first vehicle of claim 9, wherein to perform the second predetermined action, the processor is configured to output a second notification on a user interface indicating that the license plate is dirty.

11. The first vehicle of claim 9, wherein to perform the second predetermined action, the processor is configured to activate the sprayer again for a second predetermined time duration.

12. The first vehicle of claim 1, wherein the external device is a drone.

13. The first vehicle of claim 12, wherein to perform the first predetermined action, the processor is configured to request the drone to spray cleaning liquid on the license plate.

14. The first vehicle of claim 1, wherein the external device is a smart infrastructure unit.

15. The first vehicle of claim 1, wherein to perform the first predetermined action, the processor is configured to enable scheduling a vehicle wash for the first vehicle.

16. The first vehicle of claim 1, wherein to perform the first predetermined action, the processor is configured to:
obtain weather conditions from an external server;
predict a rainfall based on the weather conditions; and
adjust a vehicle position based on the prediction of the rainfall to facilitate cleaning of the license plate.

17. The first vehicle of claim 16, wherein to adjust the vehicle position, the processor is configured to adjust vehicle shock absorbers to facilitate cleaning of the license plate.

18. The first vehicle of claim 16, wherein to adjust the vehicle position, the processor is configured to reorient the first vehicle between a first orientation and a second orientation, and wherein the first orientation is different from the second orientation.

19. A vehicle comprising:
a license plate;
a transceiver configured to receive an image of the license plate from an external device; and
a processor configured to:
transmit a request to the external device to capture the image of the license plate;
obtain the image responsive to transmitting the request;
determine if the license plate is dirty based on the image; and
perform a predetermined action to clean the license plate responsive to a determination that the license plate is dirty.

20. A method comprising:
obtaining, by a processor, an image of a license plate associated with a vehicle from an external device;
determining, by the processor, that the license plate is dirty based on the image; and
causing, by the processor, a predetermined action to be performed to clean the license plate responsive to a determination that the license plate is dirty.
